(19) United States
(12) Patent Application Publication
(10) Pub. No.: US 2025/0153947 A1
(43) Pub. Date: May 15, 2025

(54) WAREHOUSE AUTOMATION-BASED MEGA VENDING MACHINE CONTROL DEVICE AND OPERATION METHOD THEREOF

(71) Applicant: RAINBOW ROBOTICS INC., Daejeon (KR)

(72) Inventors: Jun Ho OH, Seoul (KR); Jung Ho LEE, Daejeon (KR); Jung Woo HEO, Daejeon (KR); Jeong Soo LIM, Daejeon (KR)

(21) Appl. No.: 18/837,528

(22) PCT Filed: Feb. 9, 2023
(86) PCT No.: PCT/KR2023/001877

§ 371 Date: Aug. 9, 2024

(30) Foreign Application Priority Data
Mar. 31, 2022 (KR) 10-2022-0040120

(51) Int. Cl. B65G 1/137

(52) U.S. Cl. CPC B65G 1/1378; B65G 1/1371

(57) ABSTRACT

A method, according to an embodiment of the present invention, which is a method of operating a mega vending machine control device comprises the steps of: identifying individual small product from a warehousing box; picking up the identified individual small product and arranging them in each slot of the shuttle container; transporting the shuttle container to a shelf compartment area of a warehouse; and discharging the individual small products into the shelf compartment area by opening a lower side of the slot of the shuttle container and processing the completion of the warehousing of the individual small product.

### TECHNICAL FIELD

The present invention relates to a control device and a method of operating the same. More specifically, the present invention relates to a warehouse automation-based mega vending machine control device and an operation method thereof.

### BACKGROUND ART

In general, logistics management refers to the overall processes of planning accurate requirements with a focus on inventory management by developing handling items for vertical and horizontal transactions at each stage for each base in the fields of development, production, distribution and consumption and selling and distributing products in a timely manner according to demand by storing and managing only essential items and only receiving and distributing general items while procuring and purchasing of goods from high-quality suppliers and operating in check an appropriate level of inventory control. The logistics management system for this consists of processes including transportation, storage/inventory, unloading and packaging processes from the warehousing of items to shipping.

For such logistics management, various transportation methods and mechanical mechanism systems that automate the operation of the warehouse have been proposing, and in factory automation lines, etc., various warehouse automation systems that have combined conveyor belts, mobile logistics robots and so on have been proposed.

However, most of the systems proposed to date are aimed at large logistics centers and cargo warehouse management systems, which can only automate the processing of products of the same size, material and shape such as pallets, large boxes and large containers. Therefore, there are difficult problems in applying logistics management to individual small products of various sizes, materials and shapes which are handled in convenience stores, etc.

In particular, non-face-to-face product sales methods such as 24-hour unmanned convenience stores and vending machines are being preferred recently, but these small stores do not even have space to handle mobile logistics robots or large containers, and the size, material, and because the shapes are different, it is difficult to apply existing large warehouse management technologies.

Therefore, the automated management system for each individual miniaturized product is still technologically inadequate, and ultimately, even if unmanned convenience stores are operated in current small stores, a person must personally open the box, pick up the products, and place them on a shelf or vending machine. The classic method of placing products on display and having the buyer directly select the product and pay for it is being used.

The present invention has been created to solve the problems described above and its purpose is to provide a warehouse automation-based mega vending machine control device and its operation method that can be performed automatically in which by using the slot control function of the shuttle container transported between shelves, all warehousing, shelf display and order discharge are possible regardless of the shape, form, material, etc. of individual small products can be performed automatically.

### SUMMARY OF THE INVENTION

A method of operating a mega vending machine control device comprising the steps of: identifying individual small product from a warehousing box;
picking up the identified individual small product and arranging them in each slot of the shuttle container;
transporting the shuttle container to a shelf compartment area of a warehouse; and
discharging the individual small products into the shelf compartment area by opening a lower side of the slot of the shuttle container and processing the completion of the warehousing of the individual small product.

A mega vending machine control device comprising:
a recognition classification processing unit for identifying individual small products from warehousing box;
a picking manipulator driving unit for picking up the identified individual small products and places them in each slot of the shuttle container;
a shelf transport unit for transporting the shuttle container to a shelf compartment area of a warehouse;
a shuttle container driving unit for opening a lower part of the slot of the shuttle container and discharging the individual small products into the shelf partition area; and
a warehousing information processing unit for processing the completion of the warehousing of the discharged individual small products.

A shuttle container connected to a mega vending machine control device comprising: one or more slots in which individual small products picked up by a pickup manipulator of the mega vending machine control device are placed;
a transport control unit for transporting the shuttle container to a shelf compartment area of a warehouse where the individual small products are warehoused; and
a slot control unit for opening, when the shuttle container is transported to the shelf partition area, the lower part of the one or more slots and discharging the individual small products into the shelf partition area.

According to an embodiment of the present invention, an automation-based mega vending machine control device and its operation method can be provided in which by using the slot control function of the shuttle container transported between shelves, warehousing, shelf display and order discharge can all be automatically performed regardless of the shape, form, material, etc. of individual small products.

Accordingly, according to an embodiment of the present invention, there is an advantage of maximizing a space utilization in small warehouses for operating unmanned convenience stores, vending machines, etc. and minimizing human costs of sellers and buyers regarding classifying of products, displaying of them on shelves, picking up of them, and discharging of ordered products.

### BRIEF DESCRIPTION OF THE DRAWINGS

FIG. 1 is a conceptual diagram schematically illustrating the entire system according to an embodiment of the present invention.

FIG. 2 is a block diagram illustrating in more detail a warehouse automation-based mega vending machine control device according to an embodiment of the present invention.

FIG. 3 is a diagram exemplarily illustrating the warehouse automation area structure of a mega vending machine system based on shuttle container according to an embodiment of the present invention.

FIG. 4 is a block diagram illustrating in more detail a shuttle container according to an embodiment of the present invention.

FIGS. 5 and 6 are flowcharts for explaining the operation method of the warehouse automation-based mega vending machine control device according to an embodiment of the present invention.

FIGS. 7 to 11 are diagrams showing examples of a shuttle container and a shelf structure according to an embodiment of the present invention.

The following merely illustrates the principle of the invention. Therefore, although not explicitly described or shown herein, those skilled in the art will be able to invent various devices that embody the principle of the present invention and that are included in the spirit and scope of the present invention. Also, it should be understood that all conditional terms and embodiments recited herein are, in principle, expressly intended solely for the purpose of ensuring that the concept of the invention is understood and are not limited to the embodiments and conditions specifically recited as such.

Further, it should be understood that any detailed description reciting principles, aspects and embodiments of the invention as well as specific embodiments is intended to encompass structural and functional equivalents thereof. Also, these equivalents should be understood to encompass not only currently known equivalents but also equivalents to be developed in the future, that is, all elements invented to perform the same function regardless of structure.

Accordingly, for example, the block diagrams herein should be understood as representing a conceptual view of an exemplary circuit embodying the principle of the invention. Similarly, all flow diagrams, state transition diagrams, pseudo-code, etc. should be understood to represent various processes performed by a computer or processor whether or not a computer can substantially represent on a computer-readable medium and the computer or processor is explicitly shown.

Also, the clear usage of terms presented as processor, control, or similar concepts should not be construed as exclusively referring to hardware capable of executing software and should be understood as implicitly including ROM, RAM and non-volatile memory for storing software without limitation thereto. Other hardwares that are well-known or commonly used may also be included.

The above-described purpose, features and advantages will become clearer through the following detailed description in conjunction with the accompanying drawings, and accordingly, those skilled in the art will be able to easily implement the technical idea of the present invention. Also, in describing the present invention, if it is determined that a detailed description of known technologies related to the present invention may unnecessarily obscure the gist of the present invention, the detailed description thereof will be omitted.

Hereinafter, preferred embodiments according to the present invention will be described in detail with reference to the attached drawings.

### DETAILED DESCRIPTION OF THE INVENTION

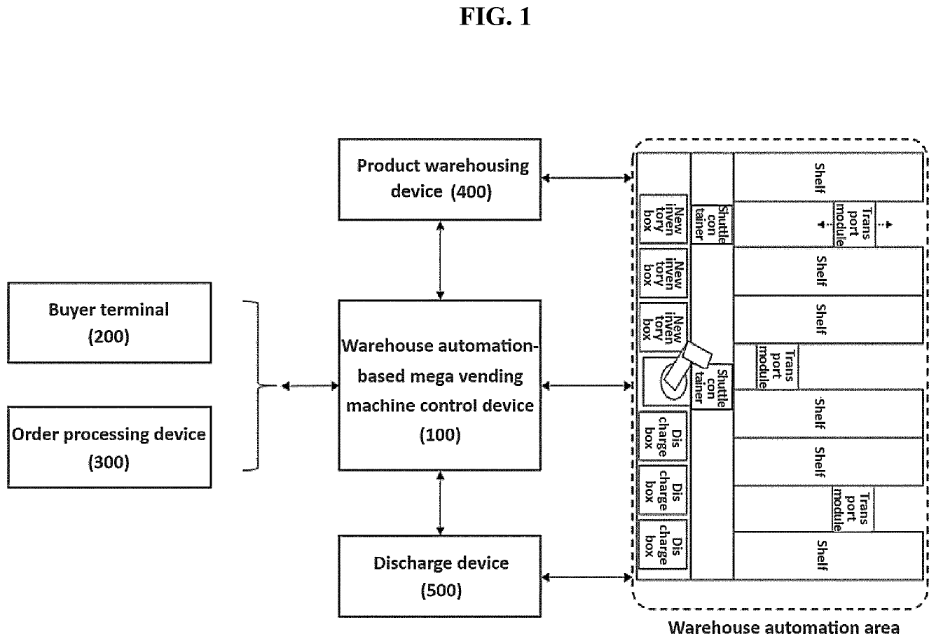

FIG. 1 is a conceptual diagram schematically showing the entire system according to an embodiment of the present invention.

Referring to FIG. 1, the entire system according to an embodiment of the present invention comprises a warehouse automation-based mega vending machine control device 100, a buyer terminal 200, an order processing device 300, a product warehousing device 400, and a discharge device 500.

The entire system may be interconnected through a communication network including a wired or wireless Internet network. In addition, a network may be configured to securely connect each communication between the warehouse automation-based mega vending machine control device 100, buyer terminal 200, order processing device 300, product warehousing device 400 and discharge device 500.

Also, each of the warehouse automation-based mega vending machine control device 100, the buyer terminal 200, the order processing device 300, the product warehousing device 400 and the discharge device 500 may have a communication module which is connected to the communication network to transmit and receive data.

The communication network may be, for example, a computer network, etc. capable of performing various data communications including an open Internet, a wired Internet network including a closed intranet, a wireless Internet networks linked to a mobile communication network and a protocol-based data communication such as transmission control protocol/Internet protocol (TCP/IP) and a user datagram protocol (UDP).

And, the buyer terminal 200 may be a buyer's terminal device that transmits order information and payment information about one or more products of products provided in the warehouse automation area to the warehouse automation-based mega vending machine control device 100 through a wireless network. The buyer terminal 200 may be, for example, mobile devices such as a tablet, a computer, a mobile phone and a smartphone.

Also, the order processing device 300 may be a device that is connected to the warehouse automation-based mega vending machine control device 100 through a wired or wireless network and that transmits product order information and payment information generated by the buyer's off-line input to the order processing device 300 to the warehouse automation-based mega vending machine control device 100. The order processing device 300 may be, for example, a kiosk device, etc. having a touch screen that generates a buying interface corresponding to a product in a warehouse automation area and that receives user input to the buying interface.

And, the warehouse automation-based mega vending machine control device 100 may be a logistics control system device in the warehouse automation area that controls the overall operations of the product warehousing device 400 and discharge device 500, conveyor and picking manipulator in the warehouse automation area and a shelf transport system.

The warehouse automation-based mega vending machine control device 100 can identify and classify inventory boxes containing individual small products when they are putted into the warehouse automation area from the product warehousing device 400 and transport them to individual compartment areas of the shelf. Based on the order information input by the buyer terminal 200 or the order processing device 300, the warehouse automation-based mega vending machine control device 100 can pick up and aggregate at least some of the individual small products and then discharge them through the discharge device 500.

To this end, when a new inventory box being stocked through the product warehousing device 400 is putted into the warehouse automation area, the warehouse automation-based mega vending machine control device 100 may first recognize and classify individual small products from the new inventory box, and control the picking manipulator which picks up the identified individual small products to pick up the identified individual small products and place them in each slot of the shuttle container.

And then, the warehouse automation-based mega vending machine control device 100 according to an embodiment of the present invention may transport the shuttle container to the shelf compartment area of the warehouse using a transport module, open the lower slot of the shuttle container to discharge the individual small products to the shelf compartment area to thereby complete the warehousing of the individual small products.

That is, in operating the shelving system in the warehouse automation area, the warehouse automation-based mega vending machine control device 100 according to an embodiment of the present invention may process the pick up and transport of each product to be driven based on the shuttle container. The shuttle container may have a partition area where each individual small product can be separately loaded and this area is referred to as a slot (SLOT) in an embodiment of the present invention. The slot according to an embodiment of the present invention may be configured by partitioning a shuttle container with a member such as a partition, and the individual small products may be loaded by classification code or by the unit of quantity.

The warehouse automation-based mega vending machine control device 100 according to an embodiment of the present invention can operate a shelf transport system through a shuttle container and remotely control the functions of opening and closing the lower part for each slot so that the individual products can be placed in a specific shelf compartment area. To this end, the warehouse automation-based mega vending machine control device 100 may generate and manage slot placement information within the shuttle container which is mapped to product identification information, and the placement information can be used in processing the transport to the shelf or transport from the shelf to the discharge basket, etc.

Also, when receiving order information from the buyer terminal or an order processing device, the warehouse automation-based mega vending machine control device 100 may identify the location information and number information on one or more individual small products corresponding to the order information and determine a transport and pick-up process for one or more shuttle containers based on the location information and number information of the individual small products.

Here, the transport and pick-up process may include a selection process of selecting a transport module and a shuttle container in order to pick up individual small products to be picked up in the shelving system into the shuttle container, a first transport process for controlling transport of the shuttle container according to the driving of the selected transport module, a pick-up process for moving the individual small products from a shelf, on which the individual small products have been displayed, to one or more first slots of the shuttle container, a second transport process for transporting the shuttle container which contains the individual small products in the slots to the discharge basket corresponding to the order information according to the driving of the transport module, and a discharge process for delivering the individual small products to the discharge basket by opening the first slot of the shuttle container.

Accordingly, the warehouse automation-based mega vending machine control device 100 may transmit control commands according to the transport and pickup process to the one or more shuttle containers, transmit, if all of the one or more individual small products picked up from the one or more shuttle containers have been collected in the discharge basket, a discharge processing command corresponding to the discharge basket to the discharge device, and perform a discharge completion processing corresponding to the order information.

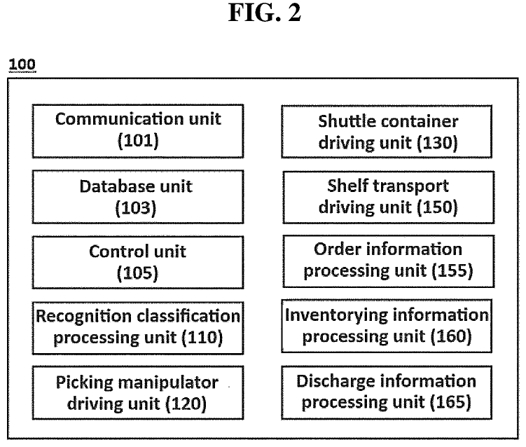

FIG. 2 is a block diagram illustrating in more detail a warehouse automation-based mega vending machine control device according to an embodiment of the present invention.

Referring to FIG. 2, the warehouse automation-based mega vending machine control device 100 according to an embodiment of the present invention includes a communication unit 101, a database unit 103, a control unit 105, a recognition classification processing unit 110, and a picking manipulator driving unit 120, a shuttle container driving unit 130, a shelf transport driving unit 150, an order information processing unit 155, an inventory information processing unit 160, and a discharge information processing unit 165.

The control unit 105 includes one or more microprocessors for entirely controlling the components of the warehouse automation-based mega vending machine control device 100.

The communication unit 105 includes one or more communication modules for communicating with the security service network.

Here, the communication unit 105 may have the forms of being connected wirelessly or wired through a local area network (LAN) and the Internet, connected through a universal serial bus (USB) port, connected through a mobile communication network such as 3G, 4G and 5G or connected through short-distance wireless communication schemes such as a near field communication (NFC), a radio frequency identification (RFID), Wi-Fi, etc.

The database unit 103 may perform mapping registration, storage and management of various information such as order information, recognition classification information, shuttle container drive information, shelf transport information, inventory information and discharge information.

Here, the shuttle container driving information may include slot placement information of the shuttle container being mapped to product identification information, and the shelf transport information may include shelf compartment area identification information corresponding to the slot placement information. The database unit 103 may separately establish, store and manage an inventory management database in managing the warehousing information and discharge information.

Meanwhile, the recognition classification processing unit 110 may identify and classify one or more individual small products from the inventory box being putted from the product warehousing device 400. For classification processing, various known visual classification systems may be used and to do this, the recognition classification processing unit 110 is equipped with one or more cameras and may identify and classify individual small products recognized through a visual classification system using a visual classification model pre-built from image information of the camera.

Also, the recognition classification processing unit 110 may transmit the image information of the inventory box to a separate user terminal, receive basic recognition classification information from the user terminal, and also perform secondary classification processing using the basic recognition classification information. That is, the basic recognition classification information may be primary classification information obtained from an external network, and the primary classification information may be directly inputted by a person or obtained through another recognition model. This can improve processing efficiency according to the distributed configuration of the recognition system.

And, the picking manipulator driving unit 120 may generate a driving command to drive a picking manipulator located in the warehouse automation area so as to pick up the identified individual small products and place them in each slot of the shuttle container, and send the driving command to the picking manipulator.

Here, the picking manipulator may include various types of picking manipulators that can pick up the identified individual small products and move them to the shuttle container, but the present invention is not limited thereto.

For example, the picking manipulator may pick up the individual small products, identify empty slots in the shuttle container and place the packed small products in the identified slots, based on various currently known schemes that include one or more finger modules driven by a servo motor, one or more suction modules driven by a vacuum suction plate, or a plurality of combined picking modules driven in a left-right tight contact manner, etc. If there are no empty slots, the picking manipulator driving unit 120 may request a shelf transport command for the currently full-filled shuttle container to the shuttle container driving unit 130 and the shelf transport driving unit 150 and an input transport command for a new empty shuttle container.

And, the shuttle container driving unit 130 may store and manage the slot placement information of the shuttle container 200 by matching the slot placement information with the identification information of individual small products, and if the shuttle container 200 is transported to the target shelf compartment area, the shuttle container driving unit 130 may transmit a driving command to open the lower part of the slot of the shuttle container and discharge the individual small products into the shelf compartment area.

The shelf transport driving unit 150 may perform a control for transporting the shuttle container to a shelf partition area of the warehouse. To do this, the shelf system may be equipped with a transport module, and the transport module may perform the function of picking up and transporting the shuttle container 200 to the shelf compartment area. Here, the transport module can be implemented as a transport module mounted on a rail located at the upper part of the warehouse automation area, a transport module coupled to a transport robot that runs in the warehouse automation area or a transport module capable of moving the shuttle container 200 along the row and column for each compartment area of the shelf in various other currently known ways.

Also, the shelf partition area may be a first shelf partition area determined according to a random access-based optimization algorithm. More specifically, the warehouse automation-based mega vending machine control device 100 according to an embodiment of the present invention may store and manage the positions of shelves and products in the warehouse automation area in a manner that allows random access to each of individual small products in the shelf system. Accordingly, the shelf transport driving unit 150 may map, store and manage the shelf placement table and product identification information for random access.

Also, in determining the first shelf partition area from which a new individual small product will be discharged, the shelf transport driving unit 150 may perform an operation to determine, by the random access way, a partition area where the required cost predicted by the transport function among the empty shelf partition areas is minimized as the first shelf partition area. For example, the shelf transport driving unit 150 may process an optimization algorithm that determines the loadable shelf and partition position, which has been determined as the closest positions corresponding to the current position of the shuttle container 200 and the product quantity, as the first shelf partition area.

Meanwhile, the warehousing information processing unit 160 may process a warehousing completion of the individual small products discharged to the shelf partition area.

More specifically, the warehousing information processing unit 160 maps and stores slot placement information corresponding to the individual small product information, and when the lower first slot of the shuttle container corresponding to the slot placement information is opened, the individual small product information is mapped and stored. The shelf compartment area identification information of the shelf compartment area where small products are discharged can be mapped to the individual small product information and stored in the inventory database of the database unit 103.

Meanwhile, the communication unit 101 may receive order information from a buyer terminal or an order processing device and transmit it to the order information processing unit 155.

And, the order information processing unit 155 may identify the location information and number information on one or more individual small products corresponding to the order information, determine a transport and pick-up process for each of one or more shuttle container based on the location information and number information on the individual small products and transmit a control command according to the transport and pick-up process to the one or more shuttle containers.

Here, the transport and pickup process for each of the one or more shuttle containers may include the steps of acquiring pickup target shelf partition area identification information corresponding to a first product, processing a transport command for the first shuttle container corresponding to the pickup target shelf partition area identification information, processing an export command of a shelf member corresponding to the pickup target shelf partition area identification information, and processing to cause the shelf member to discharge the first product into the first shuttle container.

And, when one or more individual small products picked up from the one or more shuttle containers have been all collected in the discharge basket, the discharge information processing unit 165 transmits a discharge processing command corresponding to the discharge basket to the discharge device and performs discharge completion processing corresponding to the order information.

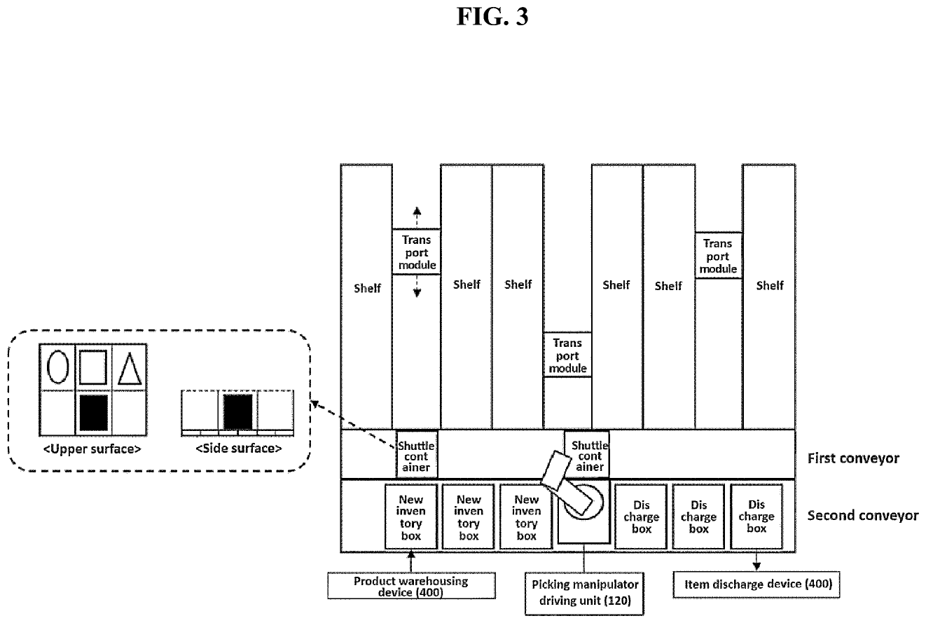

FIG. 3 is a diagram illustrating a warehouse automation area structure of the shuttle container-based mega vending machine system according to an embodiment of the present invention.

Referring to FIG. 3, the warehouse automation area structure according to an embodiment of the present invention may be provided with a picking manipulator driving unit 120 that pickups products from new inventory boxes, which are warehoused through the product warehousing device 400 and transported through a second conveyor, and disposes the products to the shuttle container 200.

And, the shuttle container may be moved through the first conveyor, and the shelf transport driving unit 150 may determine a first shelf partition area, move a first transport module a first conveyor which correspond to the first shelf including the determined first shelf partition area and control for the shuttle container to be transported through the first transport module.

And, when discharging the products according to the order information, on the contrary, the shelf transport driving unit 150 may allow the shuttle container 200 to pick up individual small products from the shelf through a transport module and take out them to the discharge basket. The discharge basket may be transported through a second conveyor and taken out to the article discharge device 400.

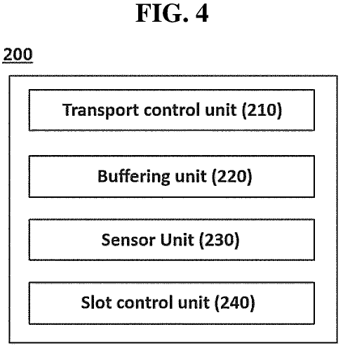

Meanwhile, the shuttle container 200 may be disposed based on a slot according to an embodiment of the present invention and equipped with a slot control unit that can be opened at the lower part to discharge the product. This will be explained in more detail with reference to FIG. 4.

FIG. 4 is a block diagram illustrating in more detail a shuttle container according to an embodiment of the present invention.

Referring to FIG. 4, the shuttle container 200 according to an embodiment of the present invention includes a transport control unit 210, a buffering unit 220, a sensor unit 230 and a slot control unit 240.

More specifically, the shuttle container 200 may be provided with one or more slots in which individual small products picked up by the pickup manipulator of the mega vending machine control device are placed as described above, and the transport control unit 210 controls the shuttle container to be transported to a shelf compartment area of a warehouse where the individual small products will be warehoused. The transport control unit 210 may be connected to the shelf transport driving unit 150 and may perform motor control, etc. according to the movement command of the shelf transport driving unit 150, thereby allowing the shuttle container 200 to be moved within the warehouse area.

And, the buffering unit 220 may be located in the lower area of each slot and may be provided with a buffering member to prevent bottom impact when individual small product is placed. The buffering member may be made of various materials such as silicone, rubber and fiber materials so that even if the product falls into the slot from a somewhat high position, the impact can be alleviated.

Also, the sensor unit 230 may be provided on the side or bottom of the slot and may be used to determine the size, shape, material, quantity, etc. of the individual small product when the product is placed. The sensing result of the sensor unit 230 may be transmitted to the shuttle container driving unit 130 and used to determine the placement information of the slot. Accordingly, the sensor unit 230 can perform the functions of sensing the presence/absence information, quantity information, size information, shape information, material information, etc. of the placed product and transmitting them to the shuttle container driving unit 130.

Meanwhile, when the shuttle container is transported to the shelf partition area, the slot control unit 240 performs a slot control function of opening the lower part of the one or more slots and discharging the individual small products into the shelf partition area. The lower part of the slot may be implemented to be opened and closed under the control of the slot control unit 240 and various opening and closing ways such as door type, sliding type, etc. can be used.

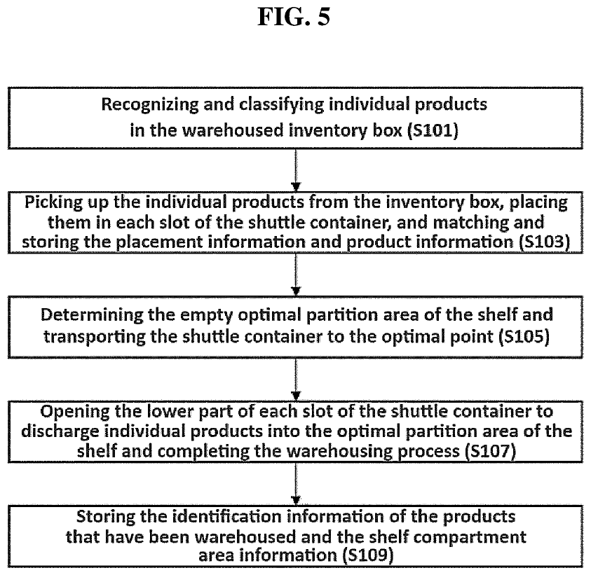

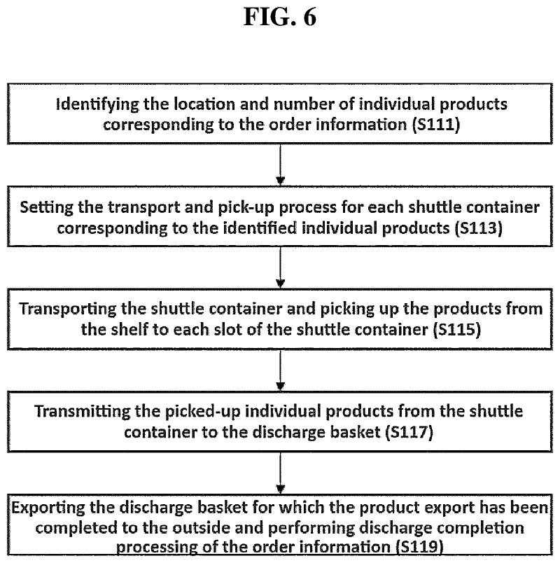

FIGS. 5 and 6 are flowcharts for explaining the operation method of the warehouse automation-based mega vending machine control device according to an embodiment of the present invention.

Referring to FIGS. 5 and 6, the warehouse automation-based mega vending machine control device 100 according to an embodiment of the present invention first recognizes and classifies individual products in inventory boxes (S101).

And, the warehouse automation-based mega vending machine control device 100 picks up individual products from the inventory box, places them in each slot of the shuttle container, and matches and stores the placement information and product information (S103).

Thereafter, the warehouse automation-based mega vending machine control device 100 determines the empty optimal partition area of the shelf based on a random access optimization algorithm and transports the shuttle container to the optimal point (S105).

Then, the warehouse automation-based mega vending machine control device 100 opens the lower part of each slot of the shuttle container to discharge individual products into the optimal partition area of the shelf and completes the warehousing process (S107).

And, the warehouse automation-based mega vending machine control device 100 stores identification information of the products that have been warehoused and shelf compartment area information (S109), identifies the location and number of individual products corresponding to the order information (S111), and sets the transport and pickup process for each shuttle container corresponding to the identified individual product (S113).

Thereafter, the warehouse automation-based mega vending machine control device 100 transports the shuttle container, picks up the products from the shelf to each slot of the shuttle container (S115), and transmits the picked individual products from the shuttle container to the discharge basket (S117).

Then, the warehouse automation-based mega vending machine control device 100 exports the discharge basket for which the product export has been completed to the outside and performs discharge completion processing of the order information (S119).

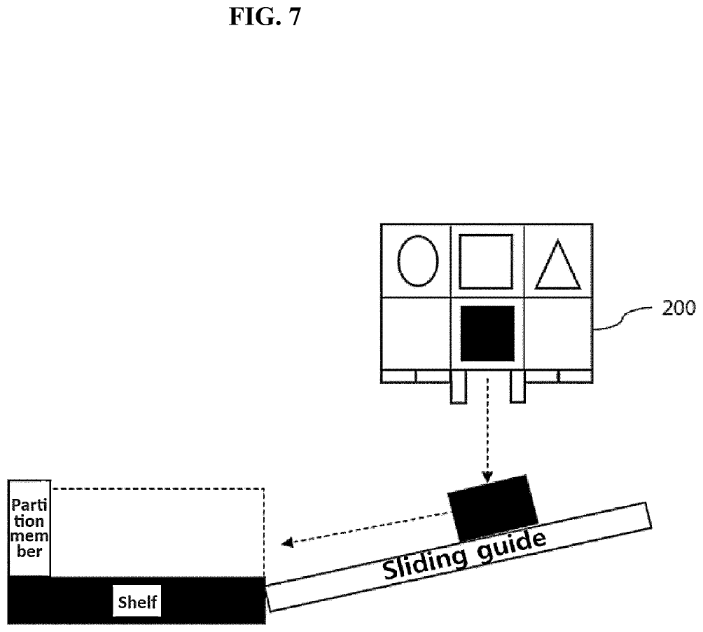

FIGS. 7 to 11 are diagrams showing examples of shuttle container and shelf structure according to embodiments of the present invention.

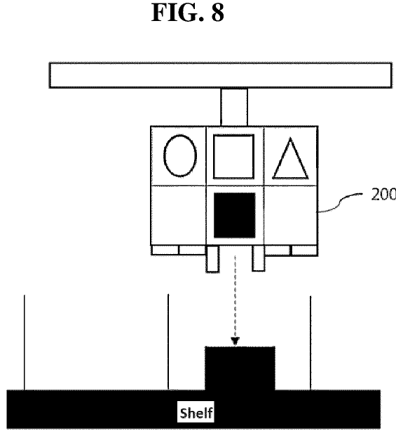

First, FIGS. 7 and 8 are diagrams illustrating a product loading method according to an embodiment of the present invention in which FIG. 7 illustrates a sliding guide method and FIG. 8 illustrates a discharging method.

As shown in FIG. 7, the transport control unit 210 according to an embodiment of the present invention may transport the shuttle container 200 so that the lower part of the slot of the shuttle container 200 is located on the sliding guide connected to the shelf partition area. Accordingly, individual small products discharged from the shuttle container 200 may be transported through the sliding guide and moved inside the partition member of the shelf.

Also, as shown in FIG. 8, the transport control unit 210 according to an embodiment of the present invention may transport the shuttle container so that the lower part of the slot of the shuttle container is located above the shelf partition area. Accordingly, the individual small products discharged from the shuttle container 200 may fall directly and be imported into the partition member of the shelf located at the bottom.

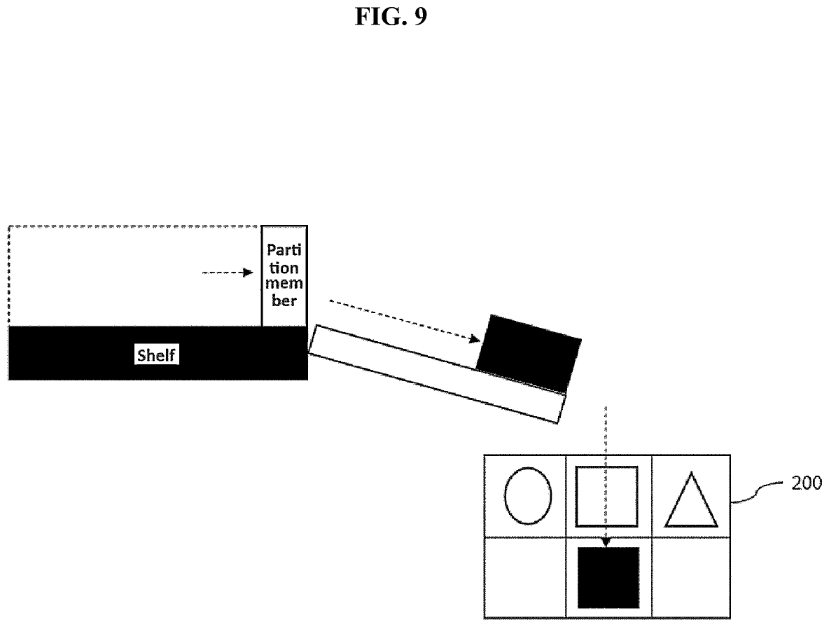

Meanwhile, FIG. 9 illustrates an export process in the sliding guide method provided as shown in FIG. 7. Referring to FIG. 9, the shelf system may be configured to move at least a part of the shelf partition member, and as the shelf partition member moves, the individual small products may be discharged into each slot of the shuttle container 200 located in the lower part through the sliding guide.

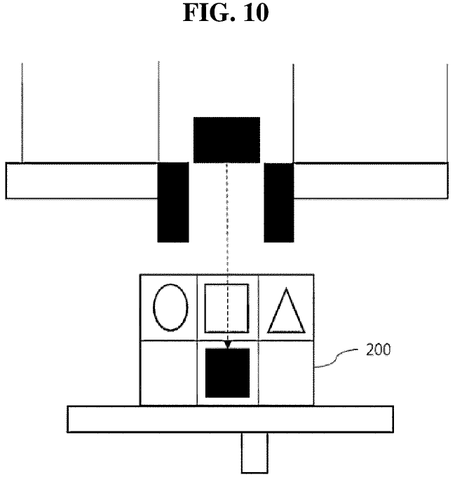

On the other hand, FIG. 10 illustrates the export process in the discharge method provided as shown in FIG. 8. Referring to FIG. 10, a lower discharge structure may be provided for each compartment area of the shelf itself, and the shelf transport driving unit 150 can operate the lower discharge structure of the shelf so that the individual small products are exported into the lower part. Accordingly, the individual small products can be discharged into each slot of the shuttle container 200 located in the lower part.

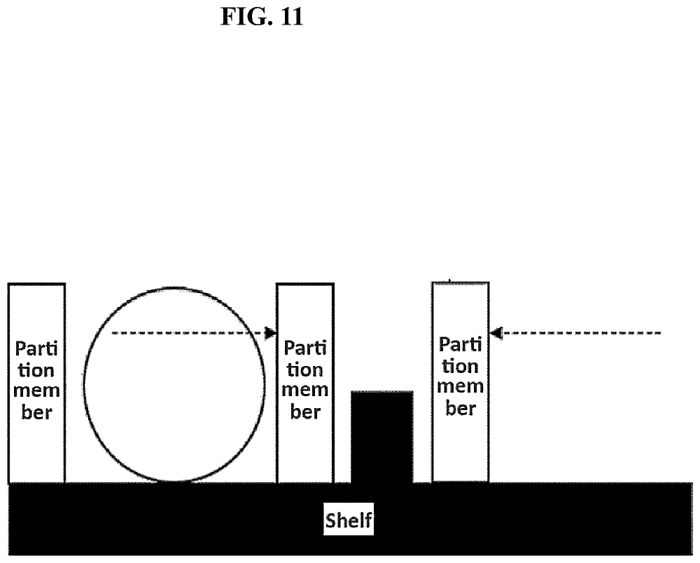

Meanwhile, FIG. 11 illustrates an operation method of a partition member of a shelf according to an embodiment of the present invention. The partition area partitioning each shelf can be variably moved depending on the size and shape of each small product. To this end, the shelf transport driving unit 150 can vary the location information of the partition member provided on the shelf, and thus the shelf system can be implemented so that the individual small products of various shapes and sizes occupy an optimized space.

And, the shelf transport driving unit 150 indexes the appropriate shelf partition area location according to at least one sensing information of the size, shape, material and quantity of the product placed in the slot and operates the partition member to thereby create an appropriate space.

The method according to the present invention described above can be produced as a program to be executed on a computer and stored in a computer-readable recording medium. Examples of computer-readable recording media include ROM, RAM, CD-ROM, magnetic tape, floppy disks, optical data storage devices, etc.

The computer-readable recording medium is distributed in a computer system connected to a network so that a computer-readable code can be stored and executed in a distributed manner. And, functional programs, codes and code segments for implementing the method can be easily deduced by programmers in the technical field to which the present invention pertains.

Also, although preferred embodiments of the present invention have been shown and described above, the present invention is not limited to the specific embodiments described above and various modifications can be made by those skilled in the art to which the invention pertains without departing from the gist of the present invention as claimed in the claims. These modifications should not be understood individually from the technical idea or perspective of the present invention.

The claims:

1. A method of operating a mega vending machine control device comprising the steps of:
identifying individual small product from a warehousing box;
picking up the identified individual small product and arranging them in each slot of the shuttle container;
transporting the shuttle container to a shelf compartment area of a warehouse; and
discharging the individual small products into the shelf compartment area by opening a lower side of the slot of the shuttle container and processing the completion of the warehousing of the individual small product.

2. The method according to claim 1, wherein the step of arranging includes mapping and storing slot placement information corresponding to the individual small product information, and wherein the step of processing the completion of warehousing includes opening a lower side of a first slot of the shuttle container corresponding to the slot placement information; and mapping shelf compartment area identification information of the shelf compartment area from which the individual small product has been discharged to the individual small product information and storing it in an inventory database.

3. The method according to claim 1, wherein the step of processing the completion of warehousing includes transporting the shuttle container so that the lower side of the slot of the shuttle container is located on a sliding guide connected to the shelf partition area.

4. The method according to claim 1, wherein the step of processing the completion of warehousing includes transporting the shuttle container so that the lower side of the slot of the shuttle container is located above the shelf partition area.

5. The method according to claim 1, further comprising the steps of:
receiving order information from a buyer terminal or order processing device;
identifying location information and number information on one or more individual small products corresponding to the order information;
determining transport and pickup process for each of one or more shuttle containers based on the location information and number information on the individual small products;
transmitting control commands according to the transport and pickup process to the one or more shuttle containers; and
when the one or more individual small products which have been picked up in the one or more shuttle containers are all collected in the discharge basket, transmitting a discharge processing command corresponding to the discharge basket to the discharge device, and performing discharge completion processing corresponding to the order information.

6. The method according to claim 5, wherein the transport and pickup process for each of the one or more shuttle containers includes the steps of:
obtaining pick-up target shelf partition area identification information corresponding to the first product;
processing a transport command of a first shuttle container corresponding to the pick-up target shelf partition area identification information; and
processing an export command of a shelf member corresponding to the pick-up target shelf partition area identification information, and processing the shelf member to discharge the first product into the first shuttle container.

7. The method according to claim 1, wherein the shelf partition area is a first shelf partition area determined according to a random access-based optimization algorithm.

8. A mega vending machine control device comprising:
a recognition classification processing unit for identifying individual small products from warehousing box;
a picking manipulator driving unit for picking up the identified individual small products and places them in each slot of the shuttle container;
a shelf transport unit for transporting the shuttle container to a shelf compartment area of a warehouse;
a shuttle container driving unit for opening a lower part of the slot of the shuttle container and discharging the individual small products into the shelf partition area; and
a warehousing information processing unit for processing the completion of the warehousing of the discharged individual small products.

9. The mega vending machine control unit according to claim 8, wherein the warehouse information processing unit maps and stores
slot placement information corresponding to the individual small product information, and when the lower part of the first slot of the shuttle container corresponding to the slot placement information is opened, the warehouse information processing unit maps the shelf partition area identification information of the shelf partition area from which the individual small product has been discharged is stored to the individual small product information and stores it in an inventory database.

10. The mega vending machine control unit according to claim 8, wherein the shelf transport unit transports the shuttle container so that the lower part of the slot of the shuttle container is located on a sliding guide connected to the shelf partition area.

11. The mega vending machine control unit according to claim 8, wherein the shelf transport unit transports the shuttle container so that the lower part of the slot of the shuttle container is located above the shelf partition area.

12. The mega vending machine control device according to claim 8, further comprising:
a communication unit for receiving order information from a buyer terminal or an order processing device;
an order information processing unit for identifying location information and number information on one or more individual small products corresponding to the order information, determining a transport and pickup process for each of one or more shuttle containers based on the location information and number information of the individual small products and transmitting a control command according to the transport and pickup process to one or more shuttle containers; and
a discharge information processing unit for transmitting, when one or more individual small products picked up in the one or more shuttle containers are all collected in the discharge basket, a discharge processing command corresponding to the discharge basket to a discharge device and performing a discharge completion processing corresponding to the order information.

13. The mega vending machine control device according to claim 12, wherein the transport and pickup process for each of the one or more shuttle containers is a process including the steps of:
obtaining pickup target shelf partition area identification information corresponding to a first product;
processing a transport command of a first shuttle container corresponding to the pickup target shelf partition area identification information; and
processing an export command of a shelf member corresponding to the pickup target shelf partition area identification information so that the shelf member discharges the first product into the first shuttle container.

14. The mega vending machine control device according to claim 8, wherein the shelf partition area is a first shelf partition area determined according to a random access-based optimization algorithm.

15. A shuttle container connected to a mega vending machine control device comprising:
one or more slots in which individual small products picked up by a pickup manipulator of the mega vending machine control device are placed;
a transport control unit for transporting the shuttle container to a shelf compartment area of a warehouse where the individual small products are warehoused; and
a slot control unit for opening, when the shuttle container is transported to the shelf partition area, the lower part of the one or more slots and discharging the individual small products into the shelf partition area.
